(19) United States
(12) Patent Application Publication
(10) Pub. No.: US 2018/0072173 A1
(43) Pub. Date: Mar. 15, 2018

(54) METHOD AND APPARATUS FOR WIRELESS POWER TRANSFER TO ELECTRIC VEHICLE USING A PLURALITY OF TRANSMISSION COILS

(71) Applicants: Hyundai Motor Company, Seoul (KR); Kia Motors Corporation, Seoul (KR)

(72) Inventors: Jong Won HWANG, Hwaseong-si (KR); Ji Hown KIM, Hwaseong-si (KR); Chang Min YANG, Hwaseong-si (KR)

(73) Assignees: Hyundai Motor Company, Seoul (KR); Kia Motors Corporation, Seoul (KR)

(21) Appl. No.: 15/702,304

(22) Filed: Sep. 12, 2017

(30) Foreign Application Priority Data
Sep. 13, 2016 (KR) 10-2016-0118402
Aug. 28, 2017 (KR) 10-2017-0108896

(51) Int. Cl. B60L 11/18; H02J 50/12; H04B 5/00; H02J 50/90

(52) U.S. Cl. CPC B60L 11/1829; H02J 50/90; H04B 5/0037; H02J 50/12

(57) ABSTRACT

A WPT method using a plurality of transmission coils may comprise checking an alignment state between a reception coil mounted on an electric vehicle (EV) and each of the plurality of transmission coils, may include selecting a transmission coil satisfying a predetermined alignment constraint among the plurality of transmission coils; and performing WPT to the reception coil using the selected transmission coil.

### CROSS-REFERENCE TO RELATED APPLICATION

The present application claims priority to Korean Patent Application No. 2016-0118402 filed on Sep. 13, 2016 and No. 2017-0108896 filed on Aug. 28, 2017, the entire contents of which is incorporated herein for all purposes by this reference.

### BACKGROUND OF THE INVENTION

### Field of the Invention

The present invention relates to an apparatus and a method for transferring wireless power to an electric vehicle (EV) using a plurality of transmission coils, and more particularly, to an apparatus and a method for transferring wireless power to an EV by selecting an optimal transmission coil among a plurality of transmission coils when performing alignment between a transmission coil and a reception coil for charging of the EV.

### Description of Related art

An electric vehicle (EV) charging system may basically be defined as a system for charging a high-voltage battery mounted on an EV by using power of an energy storage device or a power grid of a commercial power source. Such the EV charging system may have various forms according to the type of EV. For example, the EV charging system may be classified into a conductive charging type using a charging cable and a non-contact wireless power transfer (WPT) type (also referred to as an ‘inductive charging type’).

In the case of inductive charging using a WPT system, when it is necessary to charge the high-voltage battery mounted on the EV, the EV may move to a ground assembly (GA) located in a charging station or a charging spot capable of EV charging.

When charging the EV, a vehicle assembly (VA) (i.e., a reception pad in the VA) mounted on the EV makes an inductive resonance coupling with a transmission pad of the GA located in the charging station or the charging spot, and charges the battery in the EV using power transferred from the GA through the inductive resonance coupling.

On the other hand, the reception pad mounted on the EV should be aligned with the transmission pad installed on the ground to improve or secure the efficiency of wireless power transfer. If the transmission pad and the reception pad are not properly aligned, a driver (or, user) of the EV may have to perform the alignment process repeatedly, which may result in a poor user convenience.

As described above, in the WPT system for EV, there is a demand for a method of effectively aligning the coils of the transmission pad and the reception pad. In this regard, in the prior art, if coils of the GA and the VA are not properly aligned, it is necessary to repeat the alignment process by moving the EV or to adjust relative positions of the coils by using an actuator or the like mounted on the GA or VA.

However, such the method has a problem that the driver should repeatedly perform the alignment process to greatly reduce user convenience and increase a manufacturing cost by installing a separate actuator in the GA or VA.

The information disclosed in this Background of the Invention section is only for enhancement of understanding of the general background of the invention and may not be taken as an acknowledgement or any form of suggestion that this information forms the prior art already known to a person skilled in the art.

### BRIEF SUMMARY

Various aspects of the present invention are directed to providing a WPT method using a plurality of transmission coils and a WPT apparatus using a plurality of transmission coils.

According to embodiments of the present invention, a WPT method using a plurality of transmission coils may comprise checking an alignment state between a reception coil mounted on an electric vehicle (EV) and each of the plurality of transmission coils; selecting a transmission coil satisfying a predetermined alignment constraint among the plurality of transmission coils; and performing WPT to the reception coil using the selected transmission coil.

The checking an alignment state may include identifying a horizontal separation distance or a vertical separation distance between a center of the reception coil and a center of each of the plurality of transmission coils.

The checking of the alignment state may be repeatedly performed until a WPT start request message is received from the EV or a user of the EV.

The checking of the alignment state may be performed in response to receiving a WPT request message from the EV or a user of the EV.

The selecting a transmission coil may include selecting a transmission coil satisfying the predetermined alignment constraint in further consideration of WPT efficiencies of the plurality of transmission coils.

The selecting a transmission coil satisfying the predetermined alignment constraint in further consideration of WPT efficiencies of the plurality of transmission coils may include, when two or more transmission coils satisfying the predetermined alignment constraint exist, performing WPT to the reception coil by respectively using the two or more transmission coils satisfying the predetermined alignment constraint; measuring WPT efficiencies of the two or more transmission coils satisfying the predetermined alignment constraint based on a result of the WPT; and selecting a transmission coil having a largest WPT efficiency among the two or more transmission coils satisfying the predetermined alignment constraint.

The plurality of transmission coils may be disposed to partially overlap each other, and stacked in a stepped manner.

Each of the WPT efficiencies may be an amount of power transferred from a corresponding transmission coil to the reception coil for a predetermined time.

The selecting a transmission coil satisfying the predetermined alignment constraint may further include transmitting a realignment request message to the EV or a user of the EV when a transmission coil satisfying the predetermined alignment constraint does not exist.

The plurality of transmission coils may have a horizontal separation distance of 75 millimeters (mm) or less and a vertical separation distance of 100 mm or less.

Furthermore, in accordance with embodiments of the present invention, a WPT apparatus using a plurality of transmission coils may comprise at least one processor and a memory storing at least one instruction executed by the at least one processor. Also, the at least one instruction may be configured to check an alignment state between a reception coil mounted on an electric vehicle (EV) and each of the plurality of transmission coils; select a transmission coil satisfying a predetermined alignment constraint among the plurality of transmission coils; and perform WPT to the reception coil using the selected transmission coil.

The alignment state may be checked by identifying a horizontal separation distance or a vertical separation distance between a center of the reception coil and a center of each of the plurality of transmission coils.

The alignment state may be repeatedly checked until a WPT start request message is received from the EV or a user of the EV.

The alignment state may be checked in response to receiving a WPT request message from the EV or a user of the EV.

The transmission coil used for the WPT may be selected in further consideration of WPT efficiencies of the plurality of transmission coils.

When two or more transmission coils satisfying the predetermined alignment constraint exist, the transmission used for the WPT may be selected by performing WPT to the reception coil by respectively using the two or more transmission coils satisfying the predetermined alignment constraint; measuring WPT efficiencies of the two or more transmission coils satisfying the predetermined alignment constraint based on a result of the WPT; and selecting a transmission coil having a largest WPT efficiency as the transmission coil used for the WPT among the two or more transmission coils satisfying the predetermined alignment constraint.

The plurality of transmission coils may be disposed to partially overlap each other, and stacked in a stepped manner.

Each of the WPT efficiencies may be an amount of power transferred from a corresponding transmission coil to the reception coil for a predetermined time.

When a transmission coil satisfying the predetermined alignment constraint does not exist, a realignment request message may be transmitted to the EV or a user of the EV.

The plurality of transmission coils may have a horizontal separation distance of 75 millimeters (mm) or less and a vertical separation distance of 100 mm or less.

Using the WPT method and apparatus according to an exemplary embodiment of the present invention as described above, constraints required when aligning the transmission coil and the reception coil can be alleviated. Also, since the difficulty for the user or the driver to align the coils is reduced, the user convenience can be enhanced. Further, as the coil alignment can be performed precisely, the efficiency of the WPT can be improved.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF DRAWINGS

FIG. 1 is a conceptual diagram illustrating a concept of a wireless power transfer (WPT) to which an exemplary embodiment of the present invention is applied;

FIG. 2 is a conceptual diagram illustrating a wireless power transfer circuit according to an exemplary embodiment of the present invention;

FIG. 3 is a conceptual diagram for explaining a concept of alignment in an EV wireless power transfer according to an exemplary embodiment of the present invention;

FIG. 4A and FIG. 4B are conceptual diagrams for explaining a concept of a WPT using a plurality of transmission coils according to an exemplary embodiment of the present invention based on a comparison, with a conventional WPT using a single transmission coil;

FIG. 5 is a flow chart for explaining a WPT method using a plurality of transmission coils according to an exemplary embodiment of the present invention;

FIG. 6 is a flow chart for explaining a WPT method according to various exemplary embodiments of the present invention in detail;

FIG. 7 is a flow chart for explaining a WPT method according to various exemplary embodiments of the present invention in detail; and

FIG. 8 is a block diagram illustrating a WPT apparatus using a plurality of transmission coils according to an exemplary embodiment of the present invention.

It may be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particularly intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

It will be understood that although the terms “first,” “second,” etc. may be used herein to describe various components, these components should not be limited by these terms. These terms are used merely to distinguish one element from another. For example, without departing from the scope of the present invention, a first component may be designated as a second component, and similarly, the second component may be designated as the first component. The term “and/or” include any and all combinations of one of the associated listed items.

It will be understood that when a component is referred to as being “connected to” another component, it can be directly or indirectly connected to the other component. That is, for example, intervening components may be present. On the contrary, when a component is referred to as being “directly connected to” another component, it will be understood that there is no intervening components.

Terms are used herein to describe the embodiments but not to limit the present invention. Singular expressions, unless defined otherwise in contexts, include plural expressions. In the present embodiment, terms of “comprise” or “have” are used to designate features, numbers, steps, operations, elements, components or combinations thereof included in the specification as being present but not to exclude possibility of the existence or the addition of one or more other features, numbers, steps, operations, elements, components, or combinations thereof.

All terms including technical or scientific terms, unless being defined otherwise, have the same meaning generally understood by a person of ordinary skill in the art. It will be understood that terms defined in dictionaries generally used are interpreted as including meanings identical to contextual meanings of the related art, unless definitely defined otherwise in the present embodiment, are not interpreted as being ideal or excessively formal meanings.

Terms used in the present invention are defined as follows.

“Electric Vehicle, EV”: An automobile, as defined in 49 CFR 523.3, intended for highway use, powered by an electric motor that draws current from an on-vehicle energy storage device including a battery, which is rechargeable from an off-vehicle source including residential or public electric service or an on-vehicle fuel powered generator. The EV may be four or more wheeled vehicle manufactured for use primarily on public streets, roads.

The EV may be referred to as an electric car, an electric automobile, an electric road vehicle (ERV), a plug-in vehicle (PV), a plug-in vehicle (xEV), etc., and the xEV may be classified into a plug-in all-electric vehicle (BEV), a battery electric vehicle, a plug-in electric vehicle (PEV), a hybrid electric vehicle (HEV), a hybrid plug-in electric vehicle (HPEV), a plug-in hybrid electric vehicle (PHEV), etc.

“Plug-in Electric Vehicle, PEV”: An Electric Vehicle that recharges the on-vehicle primary battery by connecting to the power grid.

“Plug-in vehicle, PV”: An electric vehicle rechargeable through wireless charging from an electric vehicle supply equipment (EVSE) without using a physical plug or a physical socket.

“Heavy duty vehicle; H.D. Vehicle”: Any four-or more wheeled vehicle as defined in 49 CFR 523.6 or 49 CFR 37.3 (bus).

“Light duty plug-in electric vehicle”: A three or four-wheeled vehicle propelled by an electric motor drawing current from a rechargeable storage battery or other energy devices for use primarily on public streets, roads and highways and rated at less than 4,545 kg gross vehicle weight.

“Wireless power charging system, WCS”: A system for a wireless power transfer and control between the GA and VA including alignment and communications. This system transfers energy from the electric supply network to the electric vehicle electromagnetically through a two-part loosely coupled transformer.

“Wireless power transfer, WPT”: A transfer of electrical power from an AC supply network to an electric vehicle by contactless means.

“Utility”: A set of systems which supply electrical energy and include a customer information system (CIS), an advanced metering infrastructure (AMI), rates and revenue system, etc. The utility may provide an EV with energy through rates table and discrete events. Also, the utility may provide information related to certification on EVs, interval of power consumption measurements, and tariff.

“Smart charging”: A system in which EVSE and/or PEV communicate with power grid to optimize charging ratio or discharging ratio of EV by reflecting capacity of the power grid or expense of use.

“Automatic charging”: A procedure in which inductive charging is automatically performed after a vehicle is located in a proper position corresponding to a primary charger assembly that can transfer power. The automatic charging may be performed after obtaining necessary authentication and right.

“Interoperability”: A state in which component of a system interwork with corresponding components of the system to perform operations aimed by the system. Also, information interoperability may mean capability that two or more networks, systems, devices, applications, or components can efficiently share and easily use information without giving inconvenience to users.

“Inductive charging system”: A system transferring energy from a power source to an EV through a two-part gapped core transformer in which the two halves of the transformer, primary and secondary coils are physically separated from one another. In the present invention, the inductive charging system may correspond to an EV power transfer system.

“Inductive coupler”: A transformer formed by the coil in the GA Coil and the coil in the VA Coil that allows power to be transferred with galvanic isolation.

“Inductive coupling”: Magnetic coupling between two coils. In the present invention, coupling between the GA Coil and the VA Coil.

“Ground assembly, GA”: An assembly on the infrastructure side including the GA Coil, a power/frequency conversion device and GA controller as well as the wiring from the grid and between each device, filtering circuits, housing(s) etc., necessary to function as the power source of wireless power charging system. The GA may include the communication elements necessary for communication between the GA and the VA.

“Vehicle assembly, VA”: An assembly on the vehicle including the VA Coil, rectifier/power conversion device and VA controller as well as the wiring to the vehicle batteries and between each device, filtering circuits, housing(s), etc., necessary to function as the vehicle part of a wireless power charging system. The VA may include the communication elements necessary for communication between the VA and the GA.

The GA may be referred to as a primary device (PD), and the VA may be referred to as a secondary device (SD).

“Primary device”: An apparatus which provides the contactless coupling to the secondary device. That is, the primary device may be an apparatus external to an EV. When the EV is receiving power, the primary device may act as the source of the power to be transferred. The primary device may include the housing and all covers.

“Secondary device”: An apparatus mounted on the EV which provides the contactless coupling to the primary device. That is, the secondary device may be disposed in the EV. When the EV is receiving power, the secondary device may transfer the power from the primary to the EV. The secondary device may include the housing and all covers.

“GA controller”: A portion of the GA that regulates the output power level to the GA Coil based on information from the vehicle.

“VA controller”: A portion of the VA that monitors specific on-vehicle parameters during charging and initiates communication with the GA to control output power level.

The GA controller may be referred to as a primary device communication controller (PDCC), and the VA controller may be referred to as an electric vehicle communication controller (EVCC).

“Magnetic gap”: A vertical distance between the plane of the higher of the top portion of the litz wire or the top portion of the magnetic material in the GA Coil to the plane of the lower of the bottom portion of the litz wire or the magnetic material in the VA Coil when aligned.

“Ambient temperature”: A ground-level temperature of the air measured at the subsystem under consideration and not in direct sun light.

“Vehicle ground clearance”: A vertical distance between the ground surface and the lowest portion of the vehicle floor pan.

“Vehicle magnetic ground clearance”: A vertical distance between the plane of the lower of the bottom portion of the litz wire or the magnetic material in the VA Coil mounted on a vehicle to the ground surface.

“VA Coil magnetic surface distance”: A distance between the plane of the nearest magnetic or conducting component surface to the lower external surface of the VA coil when mounted. The present distance includes any protective coverings and additional items that may be packaged in the VA Coil enclosure.

The VA coil may be referred to as a secondary coil, a vehicle coil, or a receive coil. Similarly, the GA coil may be referred to as a primary coil, or a transmit coil.

“Exposed conductive component”: A conductive component of electrical equipment (e.g., an electric vehicle) that may be touched and which is not normally energized but which may become energized in a case of a fault.

“Hazardous live component”: A live component, which under certain conditions can give a harmful electric shock.

“Live component”: Any conductor or conductive component intended to be electrically energized in normal use.

“Direct contact”: Contact of persons with live components. (See IEC 61440)

“Indirect contact”: Contact of persons with exposed, conductive, and energized components made live by an insulation failure. (See IEC 61140)

“Alignment”: A process of finding the relative position of primary device to secondary device and/or finding the relative position of secondary device to primary device for the efficient power transfer that is specified. In the present invention, the alignment may direct to a fine positioning of the wireless power transfer system.

“Pairing”: A process by which a vehicle is correlated with the unique dedicated primary device, at which it is located and from which the power will be transferred. The pairing may include the process by which a VA controller and GA controller of a charging spot are correlated. The correlation/association process may include the process of an establishment of a relationship between two peer communication entities.

“Command and control communication”: A communication between the EV supply equipment and the EV exchanges information necessary to start, control and terminate the process of WPT.

“High level communication (HLC)”: HLC is a special kind of digital communication. HLC is necessary for additional services which are not covered by command & control communication. The data link of the HLC may use a power line communication (PLC), but it is not limited.

“Low power excitation (LPE)”: LPE means a technique of activating the primary device for the fine positioning ad pairing so that the EV can detect the primary device, and vice versa.

“Service set identifier (SSID)”: SSID is a unique identifier including 32-characters attached to a header of a packet transmitted on a wireless LAN. The SSID identifies the basic service set (BSS) to which the wireless device attempts to connect. The SSID basically distinguishes multiple wireless LANs. Therefore, all access points (Aps) and all terminal/station devices that want to use a specific wireless LAN can use the same SSID. Devices that do not use a unique SSID are not able to join the BSS. Since the SSID is shown as plain text, it may not provide any security features to the network.

“Extended service set identifier (ESSID)”: ESSID is a name of the network to which you want to connect. It is similar to SSID but can be a more extended concept.

“Basic service set identifier (BSSID)”: BSSID including 48 bits is used to distinguish a specific BSS. In the case of an infrastructure BSS network, the BSSID may be medium access control (MAC) of the AP equipment. For an independent BSS or ad hoc network, the BSSID can be generated with any value.

The charging station may comprise at least one GA and at least one GA controller managing the at least one GA. The GA may comprise at least one wireless communication device. The charging station may mean a place having at least one GA, which is disposed in home, office, public place, road, parking area, etc.

Additionally, it is understood that one or more of the below methods, or aspects thereof, may be executed by at least one controller. The term “controller” may refer to a hardware device that includes a memory and a processor. The memory is configured to store program instructions, and the processor is programmed to execute the program instructions to perform one or more processes which are described further below. Moreover, it is understood that the below methods may be executed by an apparatus including the controller in conjunction with one or more other components, as would be appreciated by a person of ordinary skill in the art.

In an exemplary embodiment of the present invention, a “rapid charging” may refer to a method of directly converting AC power of a power system to DC power, and supplying the converted DC power to a battery mounted on an EV. Here, a voltage of the DC power may be DC 500 volts (V) or less.

In an exemplary embodiment of the present invention, a “slow charging” may refer to a method of charging a battery mounted on an EV using AC power supplied to a general home or workplace. An outlet in each home or workplace, or an outlet disposed in a charging stand may provide the AC power, and a voltage of the AC power may be AC 220V or less. Here, the EV may further include an on-board charger (OBC) which is a device configured for boosting the AC power for the slow charging, converting the AC power to DC power, and supplying the converted DC power to the battery.

Hereinafter, embodiments according to an exemplary embodiment of the present invention will be explained in detail by referring to accompanying figures.

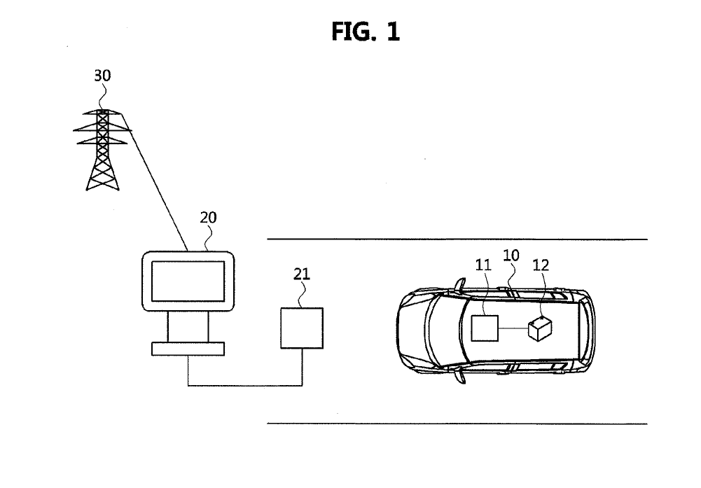

FIG. 1 is a conceptual diagram illustrating a concept of a wireless power transfer (WPT) to which an exemplary embodiment of the present invention is applied.

Referring to FIG. 1, a wireless power transfer may be performed by at least one component of an electric vehicle (EV) 10 and a charging station 13, and may be used for wirelessly transferring power to the EV 10.

Here, the EV 10 may be usually defined as a vehicle supplying an electric power stored in a rechargeable energy storage including a battery 12 as an energy source of an electric motor which is a power train system of the EV 10.

However, the EV 10 according to an exemplary embodiment of the present invention may include a hybrid electric vehicle (HEV) having an electric motor and an internal combustion engine together, and may include not only an automobile but also a motorcycle, a cart, a scooter, and an electric bicycle.

Also, the EV 10 may include a power reception pad 11 including a reception coil for charging the battery 12 wirelessly and may include a plug connection for conductively charging the battery 12. Here, the EV 10 configured for conductively charging the battery may be referred to as a plug-in electric vehicle (PEV).

Here, the charging station 13 may be connected to a power grid 15 or a power backbone, and may provide an alternating current (AC) power or a direct current (DC) power to a power transmission pad 14 including a transmission coil through a power link.

Also, the charging station 13 may communicate with an infrastructure management system or an infrastructure server that manages the power grid 15 or a power network through wired/wireless communications, and performs wireless communications with the EV 10.

Here, the wireless communications may be Bluetooth, Zigbee, cellular, wireless local area network (WLAN), or the like.

Also, for example, the charging station 13 may be located at various places including a parking area attached to the owner's house of the EV 10, a parking area for charging an EV at a gas station, a parking area at a shopping center or a workplace.

A process of wirelessly charging the battery 12 of the EV 10 may begin with first placing the power reception pad 11 of the EV 10 in an energy field generated by the power transmission pad 14 of the charging station 13, and making the reception coil and the transmission coil be interacted or coupled with each other. An electromotive force may be induced in the power reception pad 11 as a result of the interaction or coupling, and the battery 12 may be charged by the induced electromotive force.

The charging station 13 and the transmission pad 14 may be referred to as a ground assembly (GA) in whole or in part, where the GA may refer to the previously defined meaning.

All or part of internal components and the reception pad 11 of the EV 10 may be referred to as a vehicle assembly (VA), in which the VA may refer to the previously defined meaning.

Here, the power transmission pad 14 or the power reception pad 11 may be configured to be non-polarized or polarized.

In a case that a pad is non-polarized, there is one pole in a center of the pad and an opposite pole in an external periphery. Here, a flux may be formed to exit from the center of the pad and return at all to external boundaries of the pad.

In a case that a pad is polarized, it may have a respective pole at either end portion of the pad. Here, a magnetic flux may be formed based on an orientation of the pad.

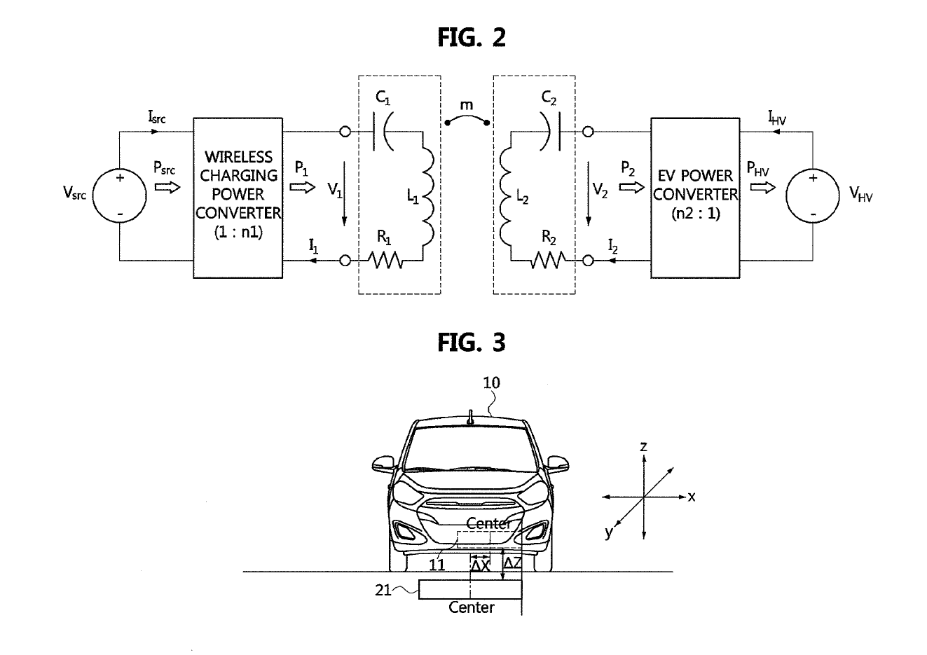

FIG. 2 is a conceptual diagram illustrating a wireless power transfer circuit according to an exemplary embodiment of the present invention.

Referring to FIG. 2, a schematic configuration of a circuit in which a wireless power transfer is performed in an EV WPT system may be seen.

Here, the left side of FIG. 2 may be interpreted as expressing all or part of a power source V_{src} supplied from the power network, the charging station 13, and the transmission pad 14 in FIG. 1, and the right side of FIG. 2 may be interpreted as expressing all or part of the EV including the reception pad and the battery.

First, the left side circuit of FIG. 2 may provide an output power P_{src} corresponding to the power source V_{src}. supplied from the power network to a wireless charging power converter. The wireless charging power converter may supply an output power P₁ converted from the output power P_{src} through frequency-converting and AC-to-DC converting to generate an electromagnetic field at a desired operating frequency in a transmission coil L₁.

The wireless charging power converter may include an AC/DC converter for converting the power P_{src} which is an AC power supplied from the power network into a DC power, and a low frequency (LF) converter for converting the DC power into a DC power having an operating frequency suitable for wireless charging. For example, the operating frequency for wireless charging may be determined to be within 80 to 90 kHz.

The power P₁ output from the wireless charging power converter may be supplied again to a circuit including the transmission coil L₁, a first capacitor C₁ and a first resistor R₁. Here, a capacitance of the first capacitor C₁ may be determined as a value to have an operating frequency suitable for charging together with the transmission coil L₁. Here, the first resistor R₁ may represent a power loss occurred by the transmission coil L₁ and the first capacitor C₁.

Further, the transmission coil L₁ may be made to have electromagnetic coupling, which is defined by a coupling coefficient m, with the reception coil L₂ so that a power P₂ is transmitted, or the power P₂ is induced in the reception coil L₂. Therefore, the meaning of power transfer in the present invention may be used together with the meaning of power induction.

Still further, the power P₂ induced in or transferred to the reception coil L₂ may be provided to an EV power converter. Here, a capacitance of a second capacitor C₂ may be determined as a value to have an operating frequency suitable for wireless charging together with the reception coil L₂, and a second resistor R₂ may represent a power loss occurred by the reception coil L₂ and the second capacitor C₂.

The EV power converter may include an LF/DC converter that converts the supplied power P₂ of a specific operating frequency to a DC power having a voltage level suitable for the battery V_{HV} of the EV.

The electric power P_{HV} converted from the power P₂ supplied to the EV power converter may be output, and the power P_{HV} may be used for charging the battery V_{EIN}/disposed in the EV.

Here, the right side circuit of FIG. 2 may further include a switch for selectively connecting or disconnecting the reception coil L₂ with the battery V_{HV}. Here, resonance frequencies of the transmission coil L₁ and the reception coil L₂ may be similar or identical to each other, and the reception coil L₂ may be positioned near the electromagnetic field generated by the transmission coil L₁.

Here, the circuit of FIG. 2 may be understood as an illustrative circuit for wireless power transfer in the EV WPT system used for embodiments of the present invention, and is not limited to the circuit illustrated in FIG. 2.

On the other hand, since the power loss may increase as the transmission coil L₁ and the reception coil L₂ are located at a long distance, it may be an important factor to properly set the relative positions of the transmission coil L₁ and the reception coil L₂.

Here, the transmission coil L₁ may be included in the transmission pad 14 in FIG. 1, and the reception coil L₂ may be included in the reception pad 11 in FIG. 1. Also, the transmission coil may refer to a GA coil, and the reception coil may refer to a VA coil. Therefore, positioning between the transmission pad and the reception pad or positioning between the EV and the transmission pad will be described below with reference to the drawings.

FIG. 3 is a conceptual diagram for explaining a concept of alignment in an EV wireless power transfer according to an exemplary embodiment of the present invention.

Referring to FIG. 3, a method of aligning the power transmission pad 14 and the power reception pad 11 in the EV in FIG. 1 will be described. Here, a positional alignment may correspond to the alignment, which is the above-mentioned term, and thus may be defined as a positional alignment between the GA and the VA, but is not limited to the alignment of the transmission pad and the reception pad.

Although the transmission pad 14 is illustrated as positioned below a ground surface as shown in FIG. 3, the transmission pad 14 may also be positioned on the ground surface, or positioned such that a top portion surface of the transmission pad 14 is exposed below the ground surface.

The reception pad 11 of the EV may be defined by different categories according to its heights (defined in the z direction) measured from the ground surface. For example, a class 1 for reception pads having a height of 100-150 millimeters (mm) from the ground surface, a class 2 for reception pads having a height of 140-210 mm, and a class 3 for reception pads having a height of 170-250 mm may be defined. Here, the reception pad may support a part of the above-described classes 1 to 3. For example, only the class 1 may be supported according to the type of the reception pad 11, or the class 1 and 2 may be supported according to the type of the reception pad 11.

Here, the height of the reception pad measured from the ground surface may correspond to the previously defined term ‘vehicle magnetic ground clearance’.

Further, the position of the power transmission pad 14 in the height direction (i.e., defined in the z direction) may be determined to be located between the maximum class and the minimum class supported by the power reception pad 11. For example, when the reception pad supports only the class 1 and 2, the position of the power transmission pad 14 may be determined between 100 and 210 mm with respect to the power reception pad 11.

Still further, a gap between the center of the power transmission pad 14 and the center of the power reception pad 11 may be determined to be located within the limits of the horizontal and vertical directions (defined in the x and y directions). For example, it may be determined to be located within ±75 mm in the horizontal direction (defined in the x direction), and within ±100 mm in the vertical direction (defined in the y direction).

Here, the relative positions of the power transmission pad 14 and the power reception pad 11 may be varied in accordance with their experimental results, and the numerical values should be understood as exemplary.

In the above description, the transmission pad 21 and the reception pad 11 were assumed to respectively include a coil and the alignment was explained as an alignment between the pads. However, the alignment may be defined as an alignment between the transmission coil (or GA coil) embedded in the transmission pad 21 and the reception coil (or VA coil) embedded in the reception pad 11.

Therefore, in the following description, the alignment between the transmission coil and the reception coil will be described. An exemplary embodiment of the present invention, in which the transmission coil includes a plurality of coils, will be described in detail.

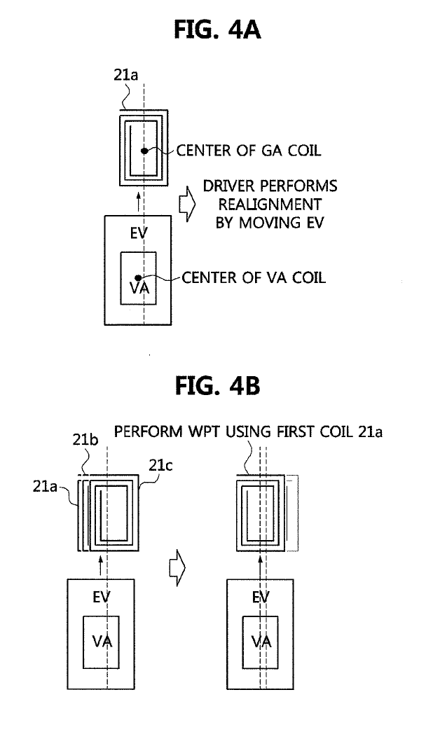

FIG. 4A and FIG. 4B are conceptual diagrams for explaining a concept of a WPT using a plurality of transmission coils according to an exemplary embodiment of the present invention based on a comparison with a conventional WPT using a single transmission coil.

Referring to FIG. 4A and FIG. 4B, a WPT method using a plurality of transmission coils (or GA coils) according to an exemplary embodiment of the present invention will be referred to as compared with a WPT method using a single transmission coil.

First, referring to FIG. 4A, a conventional WPT 40 using a single transmission coil will be referred to as a comparative example.

That is, when wireless power is transferred using a reception coil built in a VA of an EV and a single transmission coil 21a, it is required to set a constraint that the wireless power may be transmitted only when a gap between the centers of the two coils is within a certain range. This is because the efficiency of the WPT may be greatly reduced or the WPT may fail when the gap between the centers of the two coils is outside the certain range.

In the present reason, when the EV is in a state in which the above-mentioned constraint is not satisfied, it may be required to adjust the gap between the centers of the reception coil of the EV and the transmission coil embedded in the ground of the charging station by a method of moving or parking the EV again. This may seriously degrade user convenience.

On the other hand, a WPT 41 using a plurality of transmission coils according to an exemplary embodiment of the present invention may transfer wireless power to an EV as follows.

Referring to FIG. 4B, a first transmission coil 21a, a second transmission coil 21b, and a third transmission coil 21c may be provided on the ground around the charging station.

Here, the first to third transmission coils 21a, 21b, and 21c may be disposed to partially overlap each other, and the transmission coils may be disposed so that distances between the centers of the respective transmission coils have a certain interval in the horizontal (left and right) direction or the vertical (up and down) direction thereof. Further, the transmission coils may be stacked in a stepped manner.

When the EV enters an area where the transmission coils are disposed in the charging station to receive the wireless power, a coil having the largest WPT efficiency among the first to third transmission coils 21a, 21b, and 21c may be selected, and a wireless power may be transferred (or, derived) to the reception coil of the EV through the selected transmission coil.

Using the WPT 41 based on a plurality of transmission coils according to the exemplary embodiment of the present invention, since the wireless power is transmitted using a coil having the largest WPT efficiency among the plurality of transmission coils, it is made possible to alleviate burdens of alignment between the transmission coil and the reception coil than that of the WPT 40 based on a single transmission coil, and the user convenience may be improved.

It may be assumed that the plurality of transmission coils are provided near the charging station and the centers of the first to third transmission coils 21a, 21b, and 21c respectively have a horizontal interval of 75 millimeters (mm). That is, the center of the first transmission coil 21a and the center of the second transmission coil 21b have a horizontal interval of 75 mm, and the center of the second transmission coil 21b and the center of the third transmission coil 21c have a horizontal interval of 75 mm.

Under the above-described assumption, the transmission coils have totally a maximum horizontal interval of 225 mm. Further, when the reception coil of the EV is located within the maximum horizontal interval of 225 mm, the reception coil of the EV may constantly have a distance equal to or less than 75 mm from at least one transmission coil among the transmission coils. Accordingly, the alignment between the transmission coil and the reception coil may be achieved without moving the EV.

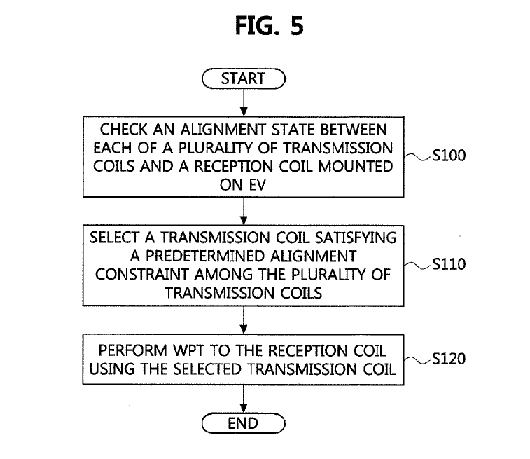

FIG. 5 is a flow chart for explaining a WPT method using a plurality of transmission coils according to an exemplary embodiment of the present invention.

Referring to FIG. 5, a WPT method using a plurality of transmission coils may comprise a step S100 of checking an alignment state between each of the plurality of transmission coils and a reception coil mounted on an EV, a step S110 of selecting a transmission coil satisfying a predetermined alignment constraint among the plurality of transmission coils, and a step S120 of transferring wireless power to the reception coil using the selected transmission coil.

Here, the predetermined alignment constraint may be the same as the gap (or distance) between the center of the transmission pad 21 and the center of the reception pad 11 defined in FIG. 3. For example, the gap between the center of the transmission coil selected from the plurality of transmission coils and the center of the reception coil may fall within ±75 mm in the horizontal direction (or, left and right direction) and fall within ±100 mm in the vertical direction (or, up and down direction).

Here, the step S100 of checking the alignment state may include a step of identifying a horizontal or vertical separation distance between the center of each of the plurality of transmission coils and the center of the reception coil.

Also, the step S100 of checking the alignment state (S100) may be repeatedly performed during the process of performing the alignment by moving the EV. That is, when the EV moves for wireless charging, the step of checking the alignment state may be automatically performed.

Also, the step S100 of checking the alignment state may be performed in response to receiving a WPT request message from the EV.

The step S110 of selecting the transmission coil satisfying the predetermined alignment constraint among the plurality of transmission coils may further include, when two or more transmission coils satisfy the predetermined alignment constraint, a step of selecting a transmission coil in further consideration of a WPT efficiency of each of the plurality of transmission coils.

Here, the step of selecting a transmission coil in further consideration of a WPT efficiency of each of the plurality of transmission coils may further comprise a step of transferring a wireless power by respectively using the two or more transmission coils during a predetermined time, a step of measuring a WPT efficiency of each of the two or more transmission coils based on a result of the transfer, and a step of finally selecting a transmission coil having the largest WPT efficiency among the two or more transmission coils satisfying the predetermined alignment constraint.

Also, the step of measuring the WPT efficiency of each of the selected transmission coils may further include a step of storing the measured WPT efficiency in a memory (or storage) to be described later.

The WPT efficiency may mean the amount of power transferred to the reception coil for the predetermined time, but is not limited thereto, and may be defined as the amount of power induced in the reception coil for the predetermined time compared to the amount of power supplied by the transmission coil for the predetermined time.

Here, the step S110 may further comprise, when a transmission coil satisfying the predetermined alignment constraint is not present, a step of transmitting a realignment request message to the EV. For example, the message may be transmitted from a SECC of the charging station to an EVCC mounted on the EV. The SECC may be a SECC disposed in or around the charging station to control communications with the EV, and the EVCC may be an EVCC mounted on the EV and controlling communications with the charging station.

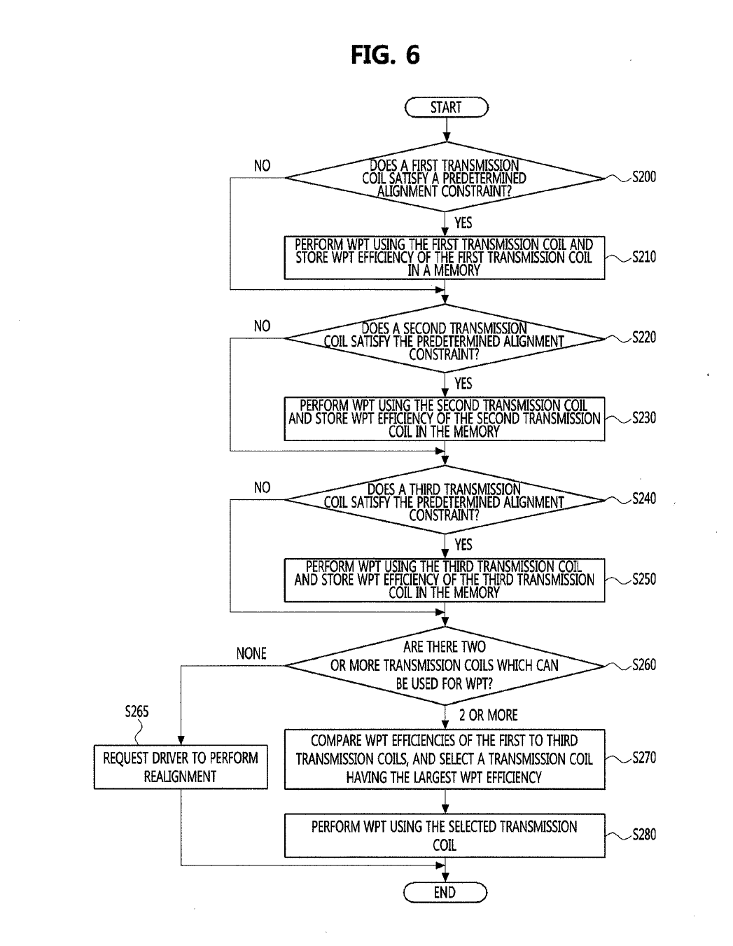

FIG. 6 is a flow chart for explaining a WPT method according to various exemplary embodiments of the present invention in detail.

Referring to FIG. 6, an example in which an optimum transmission coil to perform WPT for an EV is selected based on WPT efficiencies of transmission coils can be described.

First, when it is assumed that three transmission coils (first to third transmission coils) are provided as the plurality of transmission coils, it may be determined whether the first transmission coil satisfies the alignment constraint (S200). That is, it may be determined whether the first transmission coil is in an aligned state with the reception coil of the EV. At the present time, the step S200 may be started when the EV stops for wireless charging or when a request for starting wireless charging is made by a driver (or, user) of the EV.

Here, various methods or device including magnetic field detection, optical camera, radio frequency identification (RFID), global positioning system (GPS), and the like may additionally be used to determine whether the first transmission coil is in the aligned state.

When the first transmission coil does not satisfy the alignment constraint, it may be determined whether the second transmission coil satisfies the predetermined alignment constraint (S220). On the other hand, when the first transmission coil satisfies the predetermined alignment constraint, a WPT using the first transmission coil may be performed for a predetermined time, and a WPT efficiency of the first transmission coil may be measured and stored in a memory (S210).

As such, when the second transmission coil does not satisfy the predetermined alignment constraint, it may be determined whether the third transmission coil satisfies the alignment constraint (S240). On the other hand, when the second transmission coil satisfies the predetermined alignment constraint, a WPT using the second transmission coil may be performed for the predetermined time, and a WPT efficiency of the second transmission coil may be measured and stored in a memory (S230).

As such, when the third transmission coil satisfies the predetermined alignment constraint, a WPT using the third transmission coil may be performed for the predetermined time, and a WPT efficiency of the third transmission coil may be measured and stored in a memory (S250).

After performing the WPT procedure and storing the WPT efficiency according to whether each of the first to third transmission coils satisfies the alignment constraint (the steps S200 to S250), whether or not there is a transmission coil satisfying the alignment constraint or the number of transmission coils satisfying the alignment constraint may be determined (S260).

The step S260 may correspond to a step of identifying the number of transmission coils whose WPT efficiency (or the maximum value thereof) stored in the memory is equal to or greater than a predetermined threshold. Here, when the WPT efficiency is equal to or greater than the predetermined threshold, the corresponding transmission coil may be determined as a transmission coil which can be used for WPT, and when the WPT efficiency is less than the predetermined threshold, the corresponding transmission coil may be determined as a transmission coil which cannot be used for WPT.

As a result of the determination, when there is not a transmission coil which can be used for WPT, the realignment request message may be transmitted to the EV or the user terminal of the driver of the EV so that the driver (or, user) can recognize that the EV is not in a chargeable state (S265).

On the other hand, when it is determined that there are two or more transmission coils which can be used for WPT, a transmission coil having the largest WPT efficiency may be selected among the two or more transmission coils based on the WPT efficiencies stored in the memory (S270). That is, the step S270 may correspond to a step of selecting a transmission corresponding to the largest WPT efficiency stored in the memory.

As such, the WPT may be performed for the EV by use of the finally-selected transmission coil (S280).

According to various aspects of the present invention, when the EV driver (or, user) wants to start WPT after moving the EV to a rough alignment position, a WPT apparatus according to an exemplary embodiment of the present invention may perform WPT by respectively using the first to third transmission coils for a predetermined time (e.g., several seconds, several minutes, or less). After WPT efficiencies of the transmission coils are measured, a transmission coil having the largest WPT efficiency equal to or greater than the predetermined threshold may be automatically selected, and the WPT may be performed using the selected transmission coil.

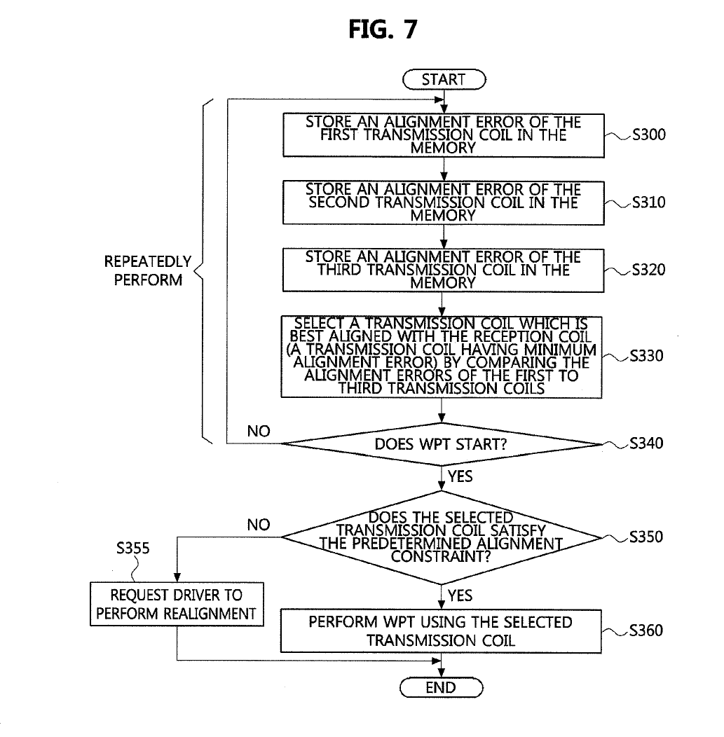

FIG. 7 is a flow chart for explaining a WPT method according to various exemplary embodiments of the present invention in detail.

Referring to FIG. 7, a method of identifying an alignment state and selecting a transmission coil having a minimum alignment error among a plurality of transmission coils can be described.

In FIG. 7, it is assumed that there are three transmission coils including the first transmission coil, the second transmission coil, and the third transmission coil, but it may be understood that it is an example.

First, an alignment state may be checked with respect to the first transmission coil, and an alignment error of the first transmission coil may be measured and stored in a memory (S300). Here, the alignment error of the first transmission coil may be defined as a difference between an actual position of the center of the first transmission coil and an optimal alignment position of a center of a transmission coil with respect to the reception coil.

Also, the measurement of the above-described alignment error value may be performed using various methods and device including magnetic field detection, optical camera, RFID, GPS, and the like.

After the step S300 or independently of the step S300, an alignment state may be checked with respect to the second transmission coil, and an alignment error of the second transmission coil may be measured and stored in the memory (S310). Also, after the step S300 or S310, or independently of the step S300 or S310, an alignment state may be checked with respect to the third transmission coil, and an alignment error of the third transmission coil may be measured and stored in the memory (S320). Here, the alignment errors for the second transmission coil and the third transmission coil may be defined in a manner similar to that of the first transmission coil.

As such, the alignment errors of the first to third transmission coils may be compared with each other, and a transmission coil having the smallest alignment error (i.e., a transmission coil best aligned with the reception coil) may be selected (S330). The step S330 may correspond to a step of selecting a transmission coil corresponding to the minimum alignment error among the alignment errors stored in the memory.

As such, a WPT start request message may be received from the user terminal of the driver or the EV according to an input of the driver (or user) (S340). At the present time, when there is no WPT start request input by the driver (or user), the steps S300 to S330 may be repeatedly performed. Here, the steps S300 to 5330 may be performed automatically at predetermined time intervals.

When there is the WPT start request input from the driver (or user), it may be determined whether the selected transmission coil satisfies the predetermined alignment constraint described above (S350). As a result of the determination in the step S350, when the selected transmission coil satisfies the predetermined alignment constraint, WPT for the EV may be performed using the selected transmission coil (S360).

On the other hand, when the selected transmission coil does not satisfy the predetermined alignment constraint, any other transmission coils with larger alignment error may not satisfy the predetermined alignment constraint, so that neither transmission coil can be used for WPT. Accordingly, at the present time, a realignment request message may be transmitted to the user terminal of the driver (or, user) or the EV (S355).

When it is determined that there is an input or signal to start WPT, it may be determined whether the selected transmission coil satisfies the predetermined alignment constraint. As a result of the determination, when the selected transmission coil satisfies the predetermined alignment constraint, the selected transmission coil may be connected to a power supply device and the WPT may be performed through the selected transmission coil. Also, as a result of the determination, when the selected transmission coil does not satisfy the predetermined alignment constraint, the realignment may be requested to the driver.

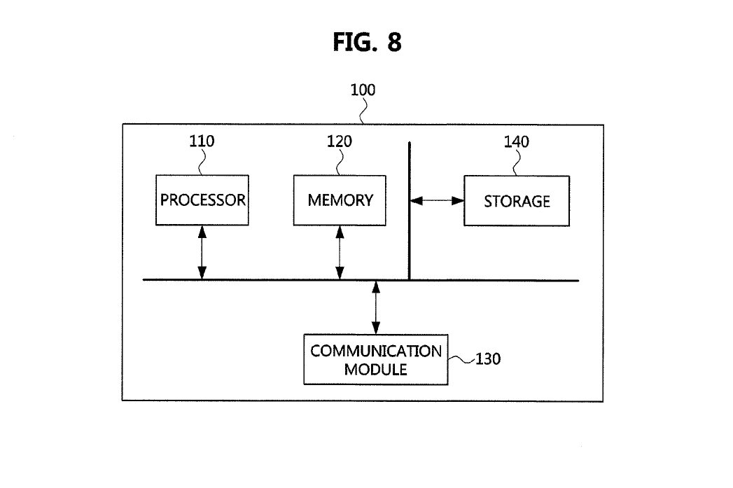

FIG. 8 is a block diagram illustrating a WPT apparatus using a plurality of transmission coils according to an exemplary embodiment of the present invention.

Referring to FIG. 8, a WPT apparatus 100 using a plurality of transmission coils may comprise at least one processor 110 and a memory 120 storing at least one instruction executed by the at least one processor 110.

Also, the WPT apparatus 100 using a plurality of transmission coils may further comprise a communication module 130 that receives an input of the driver (or, user) by communicating with an EVCC mounted on the EV or a user terminal of the driver (or, user), or transmits a message relating to WPT to the driver (or, user).

Also, the WPT apparatus 100 may further comprise a storage 140 storing measured WPT efficiencies or a result of checking alignment states of respective transmission coils. Here, the storage 140 may not exist when a role of the storage 140 is taken by the memory 120.

The at least one instruction may be configured to perform a step of checking an alignment state between a reception coil mounted on the EV and each of the plurality of transmission coils, a step of selecting a transmission coil satisfying a predetermined alignment constraint among the plurality of transmission coils, and a step of performing WPT to the reception coil by use of the selected transmission coil.

The step of checking the alignment state may include a step of identifying a horizontal or vertical separation distance between the center of each of the plurality of transmission coils and the center of the reception coil.

The step of checking the alignment state may be repeatedly performed while the EV enters and moves in the region where the plurality of transmission coils are located. Alternatively, the step of checking the alignment state may be repeatedly performed until the transmission satisfying the predetermined alignment constraint is selected. Also, the step of checking the alignment may be performed in response to receiving a WPT request message requesting WPT from the EV.

The step of selecting the transmission coil satisfying the alignment constraint among the plurality of transmission coils may further include a step of selecting a transmission coil in further consideration of a WPT efficiency of each of the plurality of transmission coils.

Also, the step of selecting the transmission coil in further consideration of a WPT efficiency of each of the plurality of transmission coils may further comprise a step of transferring a wireless power using selected transmission coils during a predetermined time when two or more transmission coils satisfy the predetermined alignment constraint, a step of measuring a WPT efficiency of each of the selected transmission coils based on a result of the transfer, and a step of finally selecting a transmission coil having the highest WPT efficiency among the selected transmission coils.

Also, the step of measuring the WPT efficiency of each of the selected transmission coils may further include a step of storing the measured WPT efficiency in a memory (or storage).

The WPT efficiency may mean the amount of power transferred to the reception coil for a predetermined time, but is not limited thereto, and may be defined as the amount of power induced in the reception coil for the predetermined time compared to the amount of power supplied by the transmission coil for the predetermined time.

Also, the step of selecting a transmission coil satisfying the predetermined alignment constraint may further comprise, when a transmission coil satisfying the predetermined alignment constraint is not present, a step of transmitting a message requesting realignment to the EV.

Here, the plurality of transmission coils may have a distance of 75 mm or less in the horizontal direction and a distance of 100 mm or less in the vertical direction thereof.

Here, the WPT apparatus 100 may correspond to all or a part of the GA or the GA controller described above, and thus may be referred to as a GA or a GA controller.

Here, the user terminal may be one of various devices including a desktop computer, a laptop computer, a smart phone, a tablet PC, a mobile phone, a smart watch, a smart glass, an e-book reader, a portable multimedia player (PMP), a portable game player, a navigation device, a digital camera, a digital multimedia broadcasting (DMB) player, a digital audio recorder, a digital audio player, a digital video recorder, a digital video player, a Personal Digital Assistant (PDA), and the like.

The methods according to embodiments of the present invention may be implemented as program instructions executable by a variety of computers and recorded on a computer readable medium. The computer readable medium may include a program instruction, a data file, a data structure, or a combination thereof. The program instructions recorded on the computer readable medium may be designed and configured for an exemplary embodiment of the present invention or can be publicly known and available to those who are skilled in the field of computer software.

Examples of the computer readable medium may include a hardware device including ROM, RAM, and flash memory, which are configured to store and execute the program instructions. Examples of the program instructions include machine codes made by, for example, a compiler, as well as high-level language codes executable by a computer, using an interpreter. The above exemplary hardware device can be configured to operate as at least one software module to perform the operation of the present invention, and vice versa.

For convenience in explanation and accurate definition in the appended claims, the terms “upper”, “lower”, “internal”, “outer”, “up”, “down”, “upper”, “lower”, “upwards”, “downwards”, “front”, “rear”, “back”, “inside”, “outside”, “inwardly”, “outwardly”, “internal”, “external”, “internal”, “outer”, “forwards”, and “backwards” are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described to explain certain principles of the invention and their practical application, to enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A wireless power transfer (WPT) method using a plurality of transmission coils, comprising:
checking an alignment state between a reception coil mounted on an electric vehicle (EV) and each of the plurality of transmission coils;
selecting a transmission coil satisfying a predetermined alignment constraint among the plurality of transmission coils; and
performing WPT to the reception coil using the selected transmission coil.

2. The WPT method, according to claim 1, wherein the checking of the alignment state includes identifying a horizontal separation distance or a vertical separation distance between a center of the reception coil and a center of each of the plurality of transmission coils.

3. The WPT method, according to claim 1, wherein the checking of the alignment state is repeatedly performed until a WPT start request message is received from the EV or a user of the EV.

4. The WPT method, according to claim 1, wherein the checking of the alignment state is performed in response to receiving a WPT request message from the EV or a user of the EV.

5. The WPT method, according to claim 1, wherein the selecting of the transmission coil includes selecting a transmission coil satisfying the predetermined alignment constraint in further consideration of WPT efficiencies of the plurality of transmission coils.

6. The WPT method, according to claim 5, wherein the selecting of the transmission coil satisfying the predetermined alignment constraint in further consideration of the WPT efficiencies of the plurality of transmission coils includes, when two or more transmission coils satisfying the predetermined alignment constraint exist,
performing the WPT to the reception coil by respectively using the two or more transmission coils satisfying the predetermined alignment constraint;
measuring WPT efficiencies of the two or more transmission coils satisfying the predetermined alignment constraint based on a result of the WPT; and
selecting a transmission coil having a largest WPT efficiency among the two or more transmission coils satisfying the predetermined alignment constraint.

7. The WPT method, according to claim 6, wherein the plurality of transmission coils are disposed to partially overlap each other, and stacked in a stepped manner.

8. The WPT method, according to claim 6, wherein each of the WPT efficiencies is an amount of power transferred from a corresponding transmission coil to the reception coil for a predetermined time.

9. The WPT method, according to claim 1, wherein the selecting of the transmission coil satisfying the predetermined alignment constraint further includes transmitting a realignment request message to the EV or a user of the EV when a transmission coil satisfying the predetermined alignment constraint does not exist.

10. The WPT method, according to claim 1, wherein the plurality of transmission coils have a horizontal separation distance of 75 millimeters (mm) or less and a vertical separation distance of 100 mm or less.

11. A wireless power transfer (WPT) apparatus using a plurality of transmission coils, comprising at least one processor and a memory storing at least one instruction executed by the at least one processor, wherein the at least one instruction is configured to:
check an alignment state between a reception coil mounted on an electric vehicle (EV) and each of the plurality of transmission coils;
select a transmission coil satisfying a predetermined alignment constraint among the plurality of transmission coils; and
perform WPT to the reception coil using the selected transmission coil.

12. The WPT apparatus, according to claim 11, wherein the alignment state is checked by identifying a horizontal separation distance or a vertical separation distance between a center of the reception coil and a center of each of the plurality of transmission coils.

13. The WPT apparatus, according to claim 11, wherein the alignment state is repeatedly checked until a WPT start request message is received from the EV or a user of the EV.

14. The WPT apparatus, according to claim 11, wherein the alignment state is checked in response to receiving a WPT request message from the EV or a user of the EV.

15. The WPT apparatus, according to claim 11, wherein the transmission coil used for the WPT is selected in further consideration of WPT efficiencies of the plurality of transmission coils.

16. The WPT apparatus, according to claim 15, wherein, when two or more transmission coils satisfying the predetermined alignment constraint exist, the transmission used for the WPT is selected by performing the WPT to the reception coil by respectively using the two or more transmission coils satisfying the predetermined alignment constraint; measuring WPT efficiencies of the two or more transmission coils satisfying the predetermined alignment constraint based on a result of the WPT; and selecting a transmission coil having a largest WPT efficiency as the transmission coil used for the WPT among the two or more transmission coils satisfying the predetermined alignment constraint.

17. The WPT apparatus, according to claim 16, wherein the plurality of transmission coils are disposed to partially overlap each other, and stacked in a stepped manner.

18. The WPT apparatus, according to claim 16, wherein each of the WPT efficiencies is an amount of power transferred from a corresponding transmission coil to the reception coil for a predetermined time.

19. The WPT apparatus, according to claim 11, wherein, when a transmission coil satisfying the predetermined alignment constraint does not exist, a realignment request message is transmitted to the EV or a user of the EV.

20. The WPT apparatus, according to claim 11, wherein the plurality of transmission coils have a horizontal separation distance of 75 millimeters (mm) or less and a vertical separation distance of 100 mm or less.
